(19) United States
(12) Patent Application Publication
(10) Pub. No.: US 2022/0191227 A1
(43) Pub. Date: Jun. 16, 2022

(54) USER BEHAVORIAL ANALYTICS FOR SECURITY ANOMALY DETECTION IN INDUSTRIAL CONTROL SYSTEMS

(71) Applicant: Siemens EnergyGlobalGmbH & Co. KG, Munich (DE)

(72) Inventors: Leandro Pfleger de Aguiar, Robbinsville, NJ (US); Bruno Paes Leao, Princeton, NJ (US); Matthew Stewart, Arlington, VA (US); Anton Kocheturov, Langhorne, PA (US)

(73) Assignee: Siemens Energy Global GmbH & Co. KG, Munich (DE)

(21) Appl. No.: 17/442,834

(22) PCT Filed: Apr. 1, 2020
(86) PCT No.: PCT/US2020/026179

§ 371 Date: Sep. 24, 2021

Related U.S. Application Data
(60) Provisional application No. 62/828,063, filed on Apr. 2, 2019.

(51) Int. Cl. H04L 9/40

(52) U.S. Cl. CPC H04L 63/1425; H04L 63/1433

(57) ABSTRACT

A method performed in an industrial control system where User and Entity Behavior Analytics (UEBA) is applied to specific actions that are performed within the industrial control system to detect security and safety anomalies related to actions of process engineers and plant operators. Malicious and non-malicious, as well as intentional and accidental, misuses of engineering workstations and human machine interfaces (HMIs) are detected.

### CROSS REFERENCE TO RELATED APPLICATIONS

This application is the US National Stage of International Application No. PCT/US2020/026179 filed 1 Apr. 2020, and claims the benefit thereof. The International Application claims the benefit of U.S. Provisional Application No. 62/828,063 filed 2 Apr. 2019. All of the applications are incorporated by reference herein in their entirety.

### TECHNICAL FIELD

This application relates to cybersecurity. The technology described herein is particularly well-suited for, but not limited to, industrial control systems for process control, factory automation, building automation, traffic management, railroad automation, or healthcare automation.

### BACKGROUND

Traditional industrial control systems are often designed without consideration of cybersecurity because it is often assumed that a given industrial control system (ICS) runs in an isolated environment. It is recognized herein, however, that recent convergence of information technology (IT) and operation technology (OT) can impose additional risk for a given ICS. An ICS often produces a large amount of data from different sources. For example, the data can include network traffic and/or logs from various systems, sensors, and actuators. Hacking into an ICS might leave traces across different layers of IT/OT infrastructures. In some cases, an attacker needs to gain access to a corporate computer to explore vulnerabilities and take control of a particular ICS control component, for example, by changing the configuration of target devices so as to change the control logic and disrupt production that is monitored and controlled by the ICS. In current approaches to cybersecurity of traditional industrial control systems, analyzing alerts and information generated from different layers often requires collaboration between different domain experts. Further, it is often a time-consuming task to link information from different data sources so as to respond to a security incident, while responses to security incidents are often time-sensitive.

### BRIEF SUMMARY

Embodiments of the invention address and overcome one or more of the described-herein shortcomings by providing methods, systems, and apparatuses that enhance security capabilities in industrial control systems. It is recognized herein that traditional anomaly detection measures for operational technology (OT) networks) focus on the network and machine communication behavior, rather than user interactions with a control system, thereby leaving a vulnerability in monitoring that potential hackers can leverage. In an example aspect, normal user interactions with an industrial control system can be modeled, and new user interactions can be compared to the models to detect anomalies.

In an example, an industrial control system (ICS) includes a production network configured to perform automated control operations. The production network comprises one or more data extraction nodes and a plurality of devices in communication with the data extraction nodes. The data extraction nodes can collect data from the plurality of devices. The data can indicate user interactions with a set of the plurality of devices. The ICS, in particular a computing system within the ICS, can extract features from the data. The features can be associated with the user interactions. Based on the features, the ICS can generate a model that defines normal or typical interactions with the set of plurality of devices. Further, the ICS, in particular data extraction nodes, can monitor the production network to extract new data related to a new user interaction with at least one of the set of the plurality of devices. The ICS can compare the new data to the model so as to detect an anomaly. Responsive to detecting the anomaly, the ICS can render an alert, for instance to an operator or security management.

### BRIEF DESCRIPTION OF THE SEVERAL VIEWS OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of an example industrial control system (ICS) in accordance with an example embodiment.

FIG. 2 is a high level flow diagram of an example operation of the ICS in accordance with an example embodiment.

FIG. 3 is a flow diagram that can be performed by a computing system and other nodes within the ICS, and thus the ICS itself, in accordance with an example embodiment.

FIG. 4 illustrates a computing environment within which embodiments of the disclosure may be implemented.

### DETAILED DESCRIPTION

It is recognized herein that traditional anomaly detection measures for operational technology (OT) networks focus on the network and machine communication behavior, rather than user interactions with a control system, thereby leaving vulnerabilities in monitoring that potential hackers can leverage. In an example aspect, normal user interactions with an industrial control system can be modeled, and new user interactions can be compared to the models to detect anomalies.

It is further recognized herein that, in the enterprise information technology (IT) space, User and Entity Behavioral Analytics (UEBA) can be implemented to model the normal behavior of users on endpoints and servers. Further, such behavior can be continuously monitored to identify anomalies, for example, by using machine learning. An example anomaly is when a seemingly legitimate user performs unexpected or malicious behavior. It is further recognized herein that current intrusion detection solutions often focus on IT only, and thus lack the capabilities to combine useful information across IT and OT. For example, security software for industrial control systems is often directly migrated from the IT domain, and thus focuses on analyzing network traffic, log information from various systems, and asset information. Additionally, uses in the IT domain are real users of corporate IT systems. Therefore, such a focus on the IT domain can fail to cover other users, such as plant operators, plant engineers, field technicians, and the like. In accordance with various embodiments described herein, however, UEBA is applied to specific actions that are performed within industrial control systems. Thus, interactions between systems and, for example and without limitation, plant operators, plant engineers, field technicians, and the like are modeled. Further, the cascaded consequences of such interactions in such systems can be modeled. For example, UEBA can be applied to process engineers and plant operators to detect security and safety anomalies, as further described herein. In particular, in some cases, malicious and non-malicious, as well as intentional and accidental, misuses of engineering workstations and human machine interfaces (HMIs) can be detected.

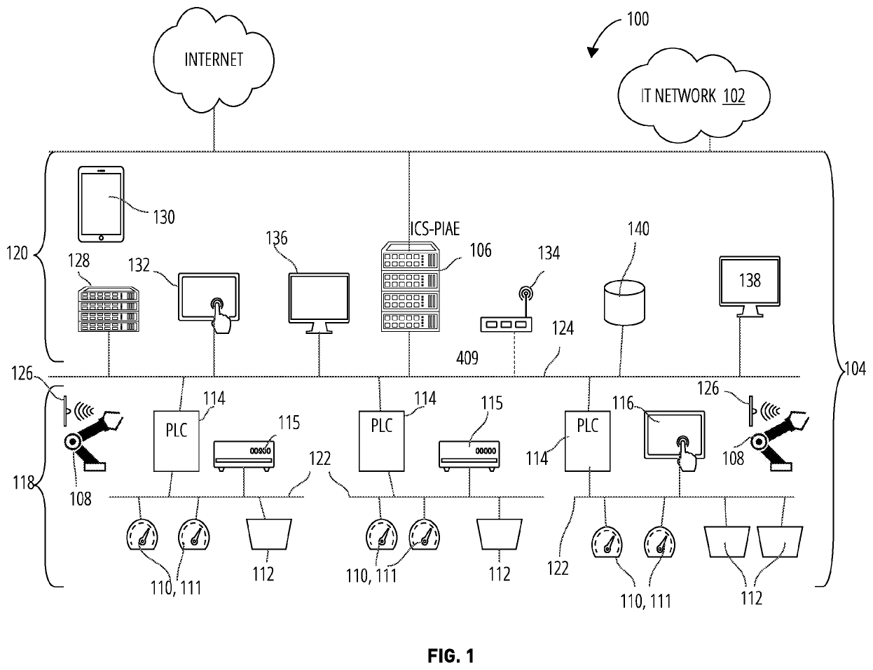

Referring initially to FIG. 1, an example distributed control system (DCS) or industrial control system (ICS) 100 includes an office or corporate IT network 102 and an operational plant or production network 104 communicatively coupled to the IT network 102. The production network 104 can include an ICS process interaction abstraction engine (ICS-PIAE) 106 that is connected to the IT network 102. The production network 104 can include various production machines configured to work together to perform one or more manufacturing operations. Example production machines of the production network 104 can include, without limitation, robots 108 and other field devices, such as sensors 110, actuators 112, or other machines, which can be controlled by a respective PLC 114. The PLC 114 can send instructions to respective field devices. In some cases, a given PLC 114 can be coupled to a human machine interfaces (HMIs) 116. It will be understood that the ICS 100 is simplified for purposes of example. That is, the ICS 100 may include additional or alternative nodes or systems, for instance other network devices, that define alternative configurations, and all such configurations are contemplated as being within the scope of this disclosure.

The ICS 100, in particular the production network 104, can define a fieldbus portion 118 and an Ethernet portion 120. For example, the fieldbus portion 118 can include the robots 108, PLC 114, sensors 110, actuators 112, and HMIs 116. The fieldbus portion 118 can define one or more production cells or control zones. The fieldbus portion 118 can further include an ICS-UEBA data extraction node 115 that can be configured to communicate with a given PLC 114 and sensors 110. In some cases, the PLC 114 can define the data extraction node 115. For example, the data extraction node 115 can run as an application or service on the PLC 114. Alternatively, the data extraction node 115 can run as an application or service on a stand-alone ruggedized personal computer or can be integrated with existing servers that can be close to, and coupled with, PLCs 114. The PLC 114, data extraction node 115, sensors 110, actuators 112, and HMI 116 within a given production cell can communicate with each other via a respective field bus 122. Each control zone can be defined by a respective PLC 114, such that the PLC 114, and thus the corresponding control zone, can connect to the Ethernet portion 120 via an Ethernet connection 124. The robots 108 can be configured to communicate with other devices within the fieldbus portion 118 via a WiFi connection 126. Similarly, the robots 108 can communicate with the Ethernet portion 120, in particular a Supervisory Control and Data Acquisition (SCADA) server 128, via the WiFi connection 126. The Ethernet portion 120 of the production network 104 can include various computing devices communicatively coupled together via the Ethernet connection 124. Example computing devices in the Ethernet portion 120 include, without limitation, a mobile data collector 130, HMIs 132, the SCADA server 128, the ICS-PIAE 106, a wireless router 134, a manufacturing execution system (MES) 136, an engineering system (ES) 138, and a log server 140. The ES 138 can include one or more engineering works stations. In an example, the MES 136, HMIs 132, ES 138, and log server 140 are connected to the production network 104 directly. The wireless router 134 can also connect to the production network 104 directly. Thus, in some cases, mobile users, for instance the mobile data collector 130 and robots 108, can connect to the production network 104 via the wireless router 134. In some cases, by way of example, the ES 138 and the mobile data collector 130 define guest devices that are allowed to connect to the ICS-PIAE 106. It will be understood that guest devices to the production network 104 can vary as desired.

With continuing reference to FIG. 1, in an example embodiment, behavior of users of the ICS 100 is monitored so as to generate models, and the generated models are used to detect anomalies. Example users of the ICS 100 include, for example and without limitation, operators of an industrial plant or engineers that can update the control logic of a plant. By way an example, an operator can interact with the HMIs 132, which may be located in a control room of a given plant. Alternatively, or additionally, an operator can interact with HMIs of the ICS 100 that are located remotely from the production network 104. Similarly, for example, engineers can use the HMIs 116 that can be located in an engineering room of the ICS 100. Alternatively, or additionally, an engineer can interact with HMIs of the ICS 100 that are located remotely from the production network 104.

In various examples, the sensors 110 can define ICS-UEBA sensors 111. The ICS-UEBA sensors 111 can collect process information, such as telemetry or data associated with user interactions. Further, a given user interaction with an HMI can result in cascaded consequences in the ICS 100, and such consequences can be detected by the ICS-UEBA sensors 111. By way of example, a cascaded consequence may include a network packet being sent or received that is only triggered after a specific user interaction. As further described herein, the telemetry or data, and thus the user interactions and consequences of the user interactions, can be modeled so as to determine typical or baseline user behavior. By way of example, the user behavior can be modeled based on a role of the user, based on the specific user themselves, or a combination thereof. The telemetry or data associated with user behavior can be extracted actively or passively. For example, the data extraction node 115 can monitor active network connections to extract system event logs so as to actively collect data associated with user behavior. The system event logs can include, for example, the description and time associated with a given set of commands or interactions. In some examples, the data extraction node 115 can extract data, for instance from the ICS-UEBA sensors 111, and parse or filter the extracted data so as to transform the extracted data into variables of interest. Further, the data extraction node 115 can notify the ICS-PIAE 106 when a new interaction with the ICS 100 is detected. The new interaction that is detected can be locally performed or remotely controlled. In some examples, the data extraction node 115 can manage an SDN gateway, such that active network reconfigurations can be performed as a response to various security alerts that are generated based on the extracted user interaction data. Additionally, data associated with user behavior can be extracted passively. For example, network traffic can be observed so as to extract operator or engineer interactions with the ICS 100. In particular, by way of example, traffic between workstations of engineers or operators, for instance the HMIs 132 or the ES 138, and the SCADA server 128 can be observed so to as extract data. Similarly, by way of further example, traffic between the SCADA server 128 and the PLCs 114 can be observed so as to extract data related to user interactions.

In some examples, the ICS 100 further includes a management system that includes a user interface. The user interface can be configured to visually or audibly render alerts. The user interface can also be configured to receive commands, such that, for example, a security team can visualize alerts and/or investigate anomalies. In an example, the management system further includes a data export interface configured to send the data that is collected to a commercial security information and event management systems (SIEM).

As described above, the ICS-PIAE 106 can receive notifications from the one or more connected control systems, in particular one or more data extraction nodes 115. By way of example, the ICS-PIAE 106 can receive a notification that a new engineer logged into the ICS 100. Such a notification may be triggered, for example, by the SCADA server 128 or by an agent running on the operating system (OS) at which the SCADA application (of the SCADA server 128) is running. The ICS-PIAE 106 can convert the notifications into standardized machine-readable ICS interaction operations. By doing so, different control systems, for instance control systems from different vendors, can be normalized. By way of example, a vector of interactions over time can be stored for a particular user of the ICS 100. Based on the stored interactions, commands that are, for example, out of order or unexpected can trigger alerts. Additionally, or alternatively, interactions with the ICS 100 can recorded as log files or can be stored directly as records in a database. Such log files can be recorded as, for example and without limitation, text files, csv files, json files, or xml files. Thus, the ICS-PIAE 106 can output a series of operator or engineer interaction codes that are can be jointly processed. In some cases, the ICS-PIAE 106 can perform pre-processing of the data. It will be understood that the data can be processed as desired for further processing by data analytics, though as an example, LogCluster is an example algorithm that can transform log entries into data that can be further processed by data analytics. In accordance with various embodiments, various data analytic algorithms can be applied to perform anomaly detection and/or classification. Such data analytic mechanisms can use machine learning and/or statistics.

It will be understood that the ICS-PIAE 106 can alternatively be deployed on the cloud, within the SCADA server 128 itself, or within a given PLC. The ICS-PIAE 206 can access a datastore in which the vectors or other interaction logs or data is stored. Further, the ICS-PIAE 106 can include or access various modules for processing data, such as modules that include one or more detection algorithms, one or more correlation algorithms, an alerting engine, and a data export interface.

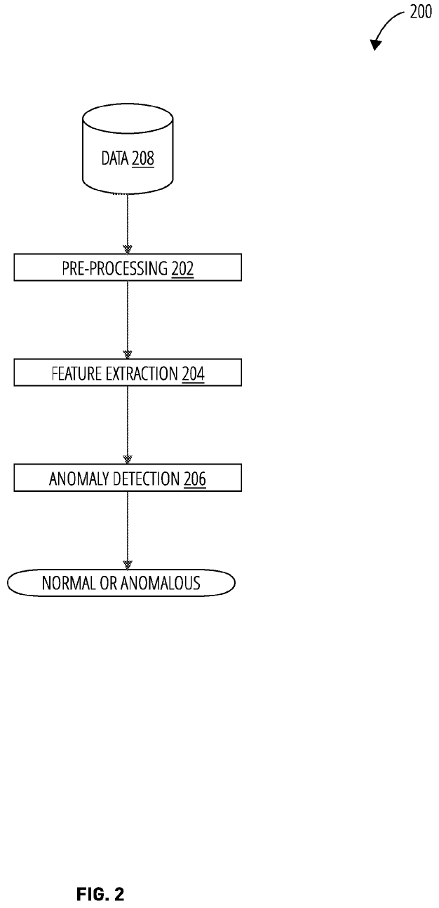

Referring also to FIG. 2, an example operation 200 can be performed by an ICS, for instance the ICS 100, in accordance with various embodiments. In some cases, cyberattacks can occur as a result of credentials being stolen from users of an ICS. Thus, it is recognized herein that anomalies can be detected by modeling the normal or typical behavior of users, and then comparing actual user behavior to the modeled user behavior. Such anomalies can define intentional cyberattacks or accidental mistakes. Regardless, responsive to the anomaly being detected, actions can be taken to mitigate or eliminate the anomaly. In some cases, the behavior of a specific individual user is modeled. Additionally, or alternatively, the behavior associated with a role in a given ICS can be modeled. Multiple specific users can be associated with a given role. By way of example, and without limitation, roles that can be modeled include an engineer, system administrator, operator, maintainer, or the like.

With continuing reference to FIG. 2, data 208 can be collected by the ICS 100, in particular the ICS-UEBA sensors 111 and the data extraction node 115. In some examples, the ICS-UEBA sensors 111 include OS-based sensors that can be deployed on the OS where the SCADA server 128 application is deployed. The ICS-UEBA sensors 111 can also include OS-based sensors for engineering workstations (e.g., of the MES 136 and ES 138) or HMIs 132 and 116. Alternatively, or additionally, the ICS-UEBA sensors 111 can be embedded on PLCs 114 so as to define embedded PLC-based sensors. In some cases, the ICS-UEBA sensors 111 perform listening only, so as to define passive network-based sensors that can extract data associated with consequences of user interactions. Alternatively, or additionally, the ICS-UEBA sensors 111 can perform polling so as to define active network-based sensors. Such active sensors can query given devices to collect data such as, for example, the latest operations performed by users of the devices. Thus, ICS 100 can include a PLC (and/or other devices) and a data collecting application configured to run on the PLC (and/or other devices). The data collecting application can be further configured to collected data associated with the PLC, or associated with other devices on which it runs.

The data 208 that is collected can include, for example and without limitation, digital information associated with an industrial process, operations, or maintenance. Alternatively, or additionally, the data can include or indicate control logic of a computer system or network such as, for example, system log files, network traffic data, or process sensor data. For example, data 208 can be extracted from the log server 140, which can include various windows logs, logs of engineer interactions, or logs related to network traffic. By way of another example, data 208 can be extracted from diagnostic buffers in PLCs 114. The data 208 can indicate which screens or windows are open on a particular workstation, and when those screens or windows are open. Further, the data 208 can indicate the order in which particular screens or windows are open, the time at or during which particular screens or windows are open, or the like. Thus, the data 208 might not be associated with typical security processes.

Further, the data 208 that is collected can include the consequence of user interactions, such that the data 208 can indicate the user interactions. For example, internal data flows of the ICS 100 can be collected, and such internal data flows can indicate user interactions, for instance user commands. Further, actions can be performed by the ICS 100 as a consequence of user interactions, for instance user commands or instructions. Data related to such actions can be collected by the ICS-UEBA sensors 111, and such actions can indicate user interactions. In particular, collecting the data 208 that indicates user interactions can include monitoring data flows that are internal to the industrial control system, monitoring responses of the industrial control system to user interactions, monitoring state information associated the industrial control system, and monitoring data from one or more memories of the industrial control system. System states can be collected so as to determine user behavior. By way of example, system state information can be collected so as to determine whether a particular window was open with a user clicked on a particular button, as expected. By way of further example, data from a system memory can be collected to determine whether a given block of data is loaded in the memory, as expected, after a given user interaction. In some cases, SCADA alarms, process variable values (e.g., sensor and actuator data), and the like can be monitored so as to collect system state information. Data 208 can also be collected so as to determine whether a response of the ICS 100 to a given user behavior or interaction is consistent with previous system response or behavior. For example, in some cases, a given user command should generate, for instance should always generate, a given system response and/or network communication.

At 202, the data can be pre-processed. Pre-processing can include, for example and without limitation, filtering out invalid values, normalizing the data, clustering log information, or the like. Pre-processing at 202 can result in log information and other sources of information being transformed into features that can be used as input for various data analytics algorithms or models.

At 204, features can be extracted from the data. Features can represent information in the form of measurable properties or characteristics. In some cases, such features are more closely connected to the final goal of processing the data 208. In some cases, features are extracted based on domain knowledge of a given ICS or production cell within an ICS. By way of example, a particular frequency of a certain type of event occurring may indicate normal or abnormal behavior of a user. Thus, the frequency of the event can be extracted, at 204. By way of another example, data mining may indicate that certain combinations or sequences of events are indicative of normal or abnormal user behavior. Thus, the combination and/or sequence of events can be extracted, at 204. Data mining may include, for example and without limitation, sequential pattern mining, interval-based temporal pattern mining, or the like. Such pattern mining can extract complex spatio-temporal patterns of user-specific and/or role-specific behavior. It will be understood that features may also be defined through a combination of domain knowledge and data-driven methods.

At 206, based on the extracted features, anomalies can be detected. In particular, the extracted features can be used to distinguish between normal and abnormal user behavior. For example, models can be generated for a specific user or role within the ICS 100. Similar to extracting features at 204, the models can be based on domain knowledge and/or data mining. Models based on domain knowledge can be applied to rule-based systems. Data-mining to generate models can include, for example and without limitation, performing Mahalanobis distance algorithms, isolation forest algorithms, and/or using other machine-learning or statistical methods. Alternatively, or additionally, models can be generated in a supervised fashion in cases when there is labeled information associated with users and/or roles. For example, users associated with roles can perform their duties in the ICS 100 so as to define a session. These sessions can be monitored so as to generate session records. Given a sufficient number of records, a classification algorithm can be trained to identity behavior patterns. By way of example, the sessions, and thus the number of records, can be defined by each time a user logs in and logs out to a particular system, or by an event, such as a change in the role associated with a workstation. In some examples, the identified behavior patterns are the best discriminants for each role, user, or user-role pair. It is recognized herein that, in some cases, the identifying behavior patterns using supervised learning can result in a higher discriminative power and a reduced search space for meaningful patterns as compared to other approaches to modeling behavior.

In some cases, in response to an anomaly being detected (at 206), an indication can be rendered by the ICS 100, for instance to an operator of the ICS 100. The indication may include an alert or alarm. The indication can be based on the type of anomaly that is detected. For example, the indication can identify what user behavior was anomalous. In some cases, depending on the anomaly for example, the alarm can be output to the HMIs 116 and/or HMIs 132 so that operators are informed of the issue. Alternatively, or additionally, alarms can be sent to security management of the ICS 100. In some examples, after an anomaly is detected, the anomaly can be classified, for example as malicious or benign. Thus, an indication or alert that is rendered can be based on the classification of the anomaly. Further still, the classification of the anomalies may depend on context associated with the ICS. Example context may include a state or condition of the ICS. By way of example, the ICS 100 might control a power plant or the like, and the power plant can define different states or conditions. Example states include, without limitation, powering up, emergency, and normal operation. By way of example, the ICS 100, in particular the ICS-PIAE 106, may identify an anomaly at 206, but may determine that the anomaly is benign because the ICS 100 is in an emergency state. For example, the ICS 100 may determine that windows at a particular workstation were opened in the correct order, for example by comparing the observed order to a model associated with the user. The ICS 100 may also determine, however, that the windows were opened at a rate that was atypical, for instance too slow or fast. Continuing with the example, when the ICS 100 is in a normal operational condition, the atypical or abnormal rate may be classified as a malicious user interaction, whereas when the ICS 100 is in an emergency state, the atypical or abnormal rate may be classified as a benign user interaction. Thus, an anomaly can be classified based on the state of a given system. Further, the detection of anomaly itself may be based on the state of a given system.

Referring again to FIG. 1, in an example, a user can open one or more screens on one of the HMIs 116 or HMIs 132 so as to define a user interaction with the ICS 100. Responsive to the user interaction, the ICS 100 can determine whether the user is valid or malicious. In some cases, the user is associated with a specific person and a role. The ICS 100, based on data extracted from logs or network traffic, can model the user and/or the role as opening up particular screens in a particular order at a particular time. In an example, when the user interaction occurs, the ICS 100 can compare the interaction to the model. Based on the comparison, the ICS 100 can determine whether the interaction is anomalous, and thus whether the user is valid. In particular, the ICS 100 can determine whether the user opened the particular screens in the particular order at the particular time, or within a predefined range.

As another example, consider a malicious attack on the ICS 100 that results in the MES 136 being instructed to open all breakers within the ICS 100. In the example, based on the data extraction, the ICS 100 knows that a legitimate operator would run a simulation before opening the breakers. Consequently, when the MES 136 receives an instruction to open all the breakers without a simulation, the ICS 100 can identify the anomaly. In particular, the ICS 100 can determine that the instruction to open all the breakers did not come from a legitimate user. In response to that determination, the ICS 100 can prevent the instruction from being carried out. As yet another example, the ICS 100 can monitor a user interaction that involves opening windows at a workstation. The ICS 100 can compare a feature of that interaction, for instance the time it takes to open the windows, to a modeled range of normal times for opening the windows. In an example in which the time is less than the lower time in the range, the ICS 100 can identify an anomaly. In particular, the ICS 100 can identify that the interaction took less time than a legitimate user could perform the interaction, which may indicate that a malicious script was written to open the windows, rather than a human operator opening the windows via one of the HMIs 116 and 132.

As yet another example, because models can be associated with users and/or roles, the ICS 100 can identify when a user is logged-in as a particular role but the user is behaving in a different role. For example, the ICS 100 can identify when a user is logged into a particular workstation of the ICS 100 as an engineer but is interacting with the workstation as an operator. Such a discrepancy can result in the ICS 100 detecting an anomaly, and taking appropriate action. Similarly, the ICS 100 can identify when a user is logged in as a specific individual but is interacting as a different individual. The individual that is logged in and the individual that is identified as interacting with the ICS 100 can be associated with the same role, or different roles. For example, in some cases, the ICS 100 can model user behavior down to the level of specific individuals, such that anomalies can be detected by comparing user interactions with interactions that are typically performed by specific individuals.

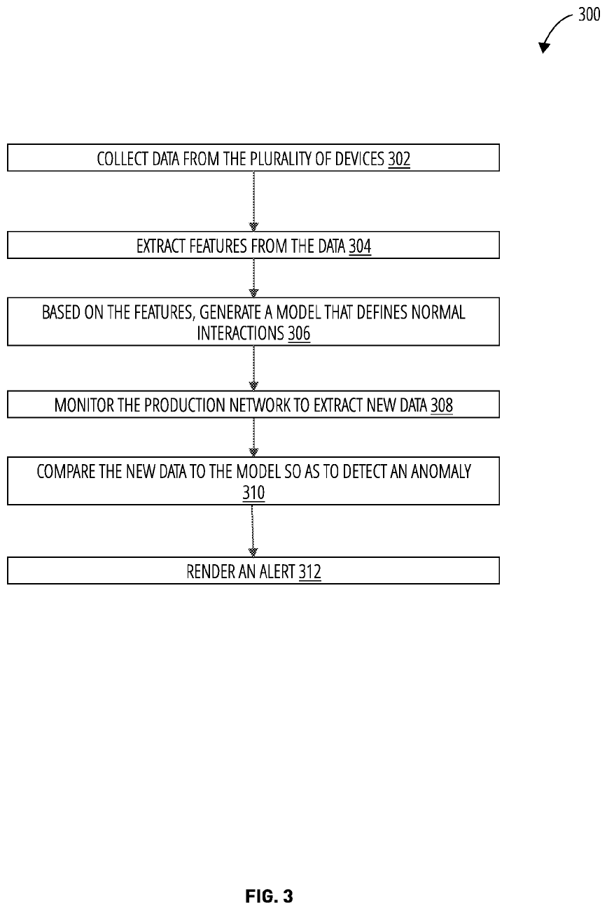

Referring now to FIG. 3, an example method 300 can be performed by a computing system within an industrial control system, for instance the ICS 100, which includes a production network configured to perform automated control operations. The computing system, and thus the production network, can include one or more data extraction nodes and a plurality of devices in communication with the data extraction nodes. At 302, the one or more data extraction nodes can collect data from the plurality of devices. The data can indicate user interactions with a set of the plurality of devices, for instance workstations, mobile devices, or HMIs within the ICS 100. Collecting data from the plurality of devices can include, for example, collecting network traffic information associated with communications among the plurality of devices, and collecting log information from the plurality of devices. At 304, features can be extracted from the data. The features are associated with the user interactions. At 306, based on the features associated with the user interactions, a model can be generated that defines normal interactions with the set of the plurality of devices. In some cases, data that that the ICS 100 generates back as a consequence of, or in response to, user interactions can also be modeled. Extracting features from the data can include determining an operational state of the industrial control system such that the normal interactions of the model that is based on the features vary based on the operational state. Additionally, or alternatively, extracting features from the data can include determining a specific individual of a plurality of specific individuals that are users performing the user interactions such that the normal interactions of the model vary based on the specific individual. Extracting features from the data can further include determining a role of a plurality of roles associated with users that are performing the user interactions, such that the normal interactions of the model that is based on the features vary based on the role. Thus, what are normal or typical user interactions can depend on the role assigned to the user, or the identity of the users themselves.

Still referring to FIG. 3, at 306, generating the model that defines normal operations can further include extracting features that define sequences of one or more operations, and time durations of the one or more operations. In an example, the plurality of devices include workstation, and the one or more operations include a user opening windows on the workstation. At 308, the production network can be monitored to extract new data related to a new user interaction with at least one of the set of the plurality of devices. At 310, the new data is compared to the model so as to detect an anomaly, as described herein. Responsive to detecting the anomaly, the ICS 100 can render an alert, at 312. For example, in some cases, the ICS 100 defines an interface configured to export alerts to commercial security information and event management systems (SIEMs).

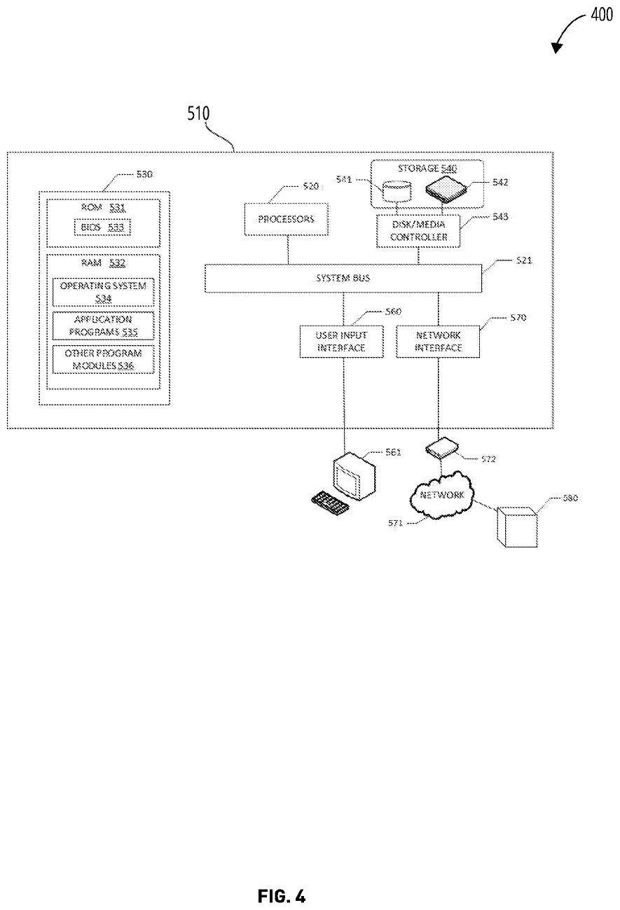

FIG. 4 illustrates an example of a computing environment within which embodiments of the present disclosure may be implemented. A computing environment 400 includes a computer system 510 that may include a communication mechanism such as a system bus 521 or other communication mechanism for communicating information within the computer system 510. The computer system 510 further includes one or more processors 520 coupled with the system bus 521 for processing the information. The robot device 108 may include, or be coupled to, the one or more processors 520.

The processors 520 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 520 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 521 may include at least one of a system bus, a memory bus, an address bus, or a message bus, and may permit exchange of information (e.g., data (including computer-executable code), signaling, etc.) between various components of the computer system 510. The system bus 521 may include, without limitation, a memory bus or a memory controller, a peripheral bus, an accelerated graphics port, and so forth. The system bus 521 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 4, the computer system 510 may also include a system memory 530 coupled to the system bus 521 for storing information and instructions to be executed by processors 520. The system memory 530 may include computer readable storage media in the form of volatile and/or nonvolatile memory, such as read only memory (ROM) 531 and/or random access memory (RAM) 532. The RAM 532 may include other dynamic storage device(s) (e.g., dynamic RAM, static RAM, and synchronous DRAM). The ROM 531 may include other static storage device(s) (e.g., programmable ROM, erasable PROM, and electrically erasable PROM). In addition, the system memory 530 may be used for storing temporary variables or other intermediate information during the execution of instructions by the processors 520. A basic input/output system 533 (BIOS) containing the basic routines that help to transfer information between elements within computer system 510, such as during start-up, may be stored in the ROM 531. RAM 532 may contain data and/or program modules that are immediately accessible to and/or presently being operated on by the processors 520. System memory 530 may additionally include, for example, operating system 534, application programs 535, and other program modules 536. Application programs 535 may also include a user portal for development of the application program, allowing input parameters to be entered and modified as necessary.

The operating system 534 may be loaded into the memory 530 and may provide an interface between other application software executing on the computer system 510 and hardware resources of the computer system 510. More specifically, the operating system 534 may include a set of computer-executable instructions for managing hardware resources of the computer system 510 and for providing common services to other application programs (e.g., managing memory allocation among various application programs). In certain example embodiments, the operating system 534 may control execution of one or more of the program modules depicted as being stored in the data storage 540. The operating system 534 may include any operating system now known or which may be developed in the future including, but not limited to, any server operating system, any mainframe operating system, or any other proprietary or non-proprietary operating system.

The computer system 510 may also include a disk/media controller 543 coupled to the system bus 521 to control one or more storage devices for storing information and instructions, such as a magnetic hard disk 541 and/or a removable media drive 542 (e.g., floppy disk drive, compact disc drive, tape drive, flash drive, and/or solid state drive). Storage devices 540 may be added to the computer system 510 using an appropriate device interface (e.g., a small computer system interface (SCSI), integrated device electronics (IDE), Universal Serial Bus (USB), or FireWire). Storage devices 541, 542 may be external to the computer system 510.

The computer system 510 may also include a field device interface 565 coupled to the system bus 521 to control a field device 566, such as a device used in a production line. The computer system 510 may include a user input interface or GUI 561, which may comprise one or more input devices, such as a keyboard, touchscreen, tablet and/or a pointing device, for interacting with a computer user and providing information to the processors 520.

The computer system 510 may perform a portion or all of the processing steps of embodiments of the invention in response to the processors 520 executing one or more sequences of one or more instructions contained in a memory, such as the system memory 530. Such instructions may be read into the system memory 530 from another computer readable medium of storage 540, such as the magnetic hard disk 541 or the removable media drive 542. The magnetic hard disk 541 (or solid state drive) and/or removable media drive 542 may contain one or more data stores and data files used by embodiments of the present disclosure. The data store 540 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 520 may also be employed in a multi-processing arrangement to execute the one or more sequences of instructions contained in system memory 530. In alternative embodiments, hard-wired circuitry may be used in place of or in combination with software instructions. Thus, embodiments are not limited to any specific combination of hardware circuitry and software.

As stated above, the computer system 510 may include at least one computer readable medium or memory for holding instructions programmed according to embodiments of the invention and for containing data structures, tables, records, or other data described herein. The term “computer readable medium” as used herein refers to any medium that participates in providing instructions to the processors 520 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 541 or removable media drive 542. Non-limiting examples of volatile media include dynamic memory, such as system memory 530. Non-limiting examples of transmission media include coaxial cables, copper wire, and fiber optics, including the wires that make up the system bus 521. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 400 may further include the computer system 510 operating in a networked environment using logical connections to one or more remote computers, such as remote computing device 580. The network interface 570 may enable communication, for example, with other remote devices 580 or systems and/or the storage devices 541, 542 via the network 571. Remote computing device 580 may be a personal computer (laptop or desktop), a mobile device, a server, a router, a network PC, a peer device or other common network node, and typically includes many or all of the elements described above relative to computer system 510. When used in a networking environment, computer system 510 may include modem 572 for establishing communications over a network 571, such as the Internet. Modem 572 may be connected to system bus 521 via user network interface 570, or via another appropriate mechanism.

Network 571 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 510 and other computers (e.g., remote computing device 580). The network 571 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 571.

It should be appreciated that the program modules, applications, computer-executable instructions, code, or the like depicted in FIG. 4 as being stored in the system memory 530 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 510, the remote device 580, and/or hosted on other computing device(s) accessible via one or more of the network(s) 571, may be provided to support functionality provided by the program modules, applications, or computer-executable code depicted in FIG. 4 and/or additional or alternate functionality. Further, functionality may be modularized differently such that processing described as being supported collectively by the collection of program modules depicted in FIG. 4 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 4 may be implemented, at least partially, in hardware and/or firmware across any number of devices.

It should further be appreciated that the computer system 510 may include alternate and/or additional hardware, software, or firmware components beyond those described or depicted without departing from the scope of the disclosure. More particularly, it should be appreciated that software, firmware, or hardware components depicted as forming part of the computer system 510 are merely illustrative and that some components may not be present or additional components may be provided in various embodiments. While various illustrative program modules have been depicted and described as software modules stored in system memory 530, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Without being bound by theory, it is recognized herein that generating models that focus on a specific user and/or role, in accordance with various embodiments, can enhance security capabilities as compared to generic anomaly detection models, such as models that focus on users in a corporate network. For example, such focused models can be used to detect security and/or safety events that might not otherwise be identified.

1. A method performed in an industrial control system that includes a production network configured to perform automated control operations, the production network comprising one or more data extraction nodes and a plurality of devices in communication with the data extraction nodes, the method comprising:
collecting, by the one or more data extraction nodes, data from the plurality of devices, the data indicating user interactions with a set of the plurality of devices;
extracting features from the data, the features associated with the user interactions;
based on the features, generating a model that defines normal interactions with the set of the plurality of devices;
monitoring the production network to extract new data related to a new user interaction with at least one of the set of the plurality of devices;
comparing the new data to the model so as to detect an anomaly; and
responsive to detecting the anomaly, rendering an alert.

2. The method of claim 1, wherein collecting data indicating user interactions comprises:
monitoring data flows that are internal to the industrial control system; and
monitoring responses of the industrial control system to user interactions.

3. The method of claim 1, wherein extracting features from the data further comprises:
determining an operational state of the industrial control system such that the normal interactions of the model that is based on the features vary based on the operational state.

4. The method of claim 1, wherein generating the model that defines normal interactions further comprises:
extracting features that define sequences of one or more operations, and time durations of the one or more operations.

5. The method of claim 4, wherein the plurality of devices comprises a workstation, and the one or more operations comprise a user interaction of opening windows on the workstation.

6. The method of claim 5, wherein generating the model that defines normal interactions further comprises:
extracting features that define network traffic that is received by, and sent from, the workstation; and
generating a correlation between the network traffic and the user interaction of opening windows on the workstation.

7. The method of claim 1, wherein collecting data from the plurality of devices further comprises:
collecting network traffic information associated with communications among the plurality of devices;
collecting log information from the plurality of devices;
collecting state information associated the industrial control system; and
collecting data from a memory of the industrial control system.

8. The method of claim 1, wherein extracting features from the data further comprises:
determining a specific individual of a plurality of specific individuals that are users that are performing the user interactions, such that the normal interactions of the model vary based on the specific individual.

9. The method of claim 1, wherein extracting features from the data further comprises:
determining a role of a plurality of roles associated with users that are performing the user interactions, such that the normal interactions of the model that is based on the features vary based on the role.

10. An industrial control system comprising:
a production network configured to perform automated control operations, the production network comprising one or more data extraction nodes and a plurality of devices in communication with the data extraction nodes, the data extraction nodes configured to collect data from the plurality of devices, the data indicating user interactions with a set of the plurality of devices;
a processor; and
a memory storing instructions that, when executed by the processor, cause the industrial control system to:
extract features from the data, the features associated with the user interactions;
based on the features, generate a model that defines normal interactions with the set of the plurality of devices;
monitor the production network to extract new data related to a new user interaction with at least one of the set of the plurality of devices;
compare the new data to the model so as to detect an anomaly; and
responsive to detecting the anomaly, render an alert.

11. The industrial control system of claim 10, the industrial control system further comprising:
a programmable logic controller (PLC) and a data collecting application configured to run on the PLC, the data collecting application further configured to collect data associated with the PLC.

12. The industrial control system of claim 10, wherein the instructions further cause the industrial control system to:
determine an operational state of the industrial control system such that the normal interactions of the model that is based on the features vary based on the operational state.

13. The industrial control system of claim 10, wherein the instructions further cause the industrial control system to:
extract features that define sequences of one or more operations, and time durations of the one or more operations.

14. The industrial control system of claim 13, wherein the plurality of devices comprises a workstation, and the one or more operations comprise a user interaction of opening windows on the workstation.

15. The industrial control system of claim 14, wherein the instructions further cause the industrial control system to:
extract features that define network traffic that is received by, and sent from, the workstation; and
generate a correlation between the network traffic and the user interaction of opening windows on the workstation.

16. The industrial control system of claim 13, wherein the instructions further cause the industrial control system to:
extract features that define network traffic that is received by, and sent from, a workstation; and
generate a correlation between the network traffic and a user interaction of opening windows on the workstation.

17. The industrial control system of claim 10, wherein the data extraction nodes are further configured to:
collect network traffic information associated with communications among the plurality of devices; and
collect log information from the plurality of devices.

18. The industrial control system of claim 10, wherein the instructions further cause the industrial control system to:
determine a specific individual of a plurality of specific individuals that are users that are performing the user interactions, such that the normal interactions of the model vary based on the specific individual; and
determine a role of a plurality of roles associated with users that are performing the user interactions, such that the normal interactions of the model that is based on the features vary based on the role.

19. The industrial control system of claim 10, the industrial control system further comprising:
a management system comprising a user interface, the user interface configured to visually render the alerts.

20. The industrial control system of claim 19, wherein the management system further comprises a data export interface configured to send the data that is collected to a commercial security information and event management systems (SIEM).
